(19) United States
(12) Patent Application Publication
(10) Pub. No.: US 2014/0332405 A1
(43) Pub. Date: Nov. 13, 2014

(54) HYDROGEN PRODUCTION PROCESS WITH CARBON DIOXIDE RECOVERY

(71) Applicants: Satish S. Tamhankar, Scotch Plains, NJ (US); Ramachandran Krishnamurthy, Chestnut Ridge, NY (US)

(72) Inventors: Satish S. Tamhankar, Scotch Plains, NJ (US); Ramachandran Krishnamurthy, Chestnut Ridge, NY (US)

(21) Appl. No.: 13/889,730

(22) Filed: May 8, 2013

(51) Int. Cl. C01B 3/50; C25B 1/02

(52) U.S. Cl. CPC C01B 3/50; C01B 3/508; C25B 1/02
USPC 205/763

(57) ABSTRACT

A method for producing hydrogen by performing the steps of feeding a synthesis gas mixture to a pressure swing adsorption unit; producing hydrogen from the synthesis gas mixture in the pressure swing adsorption unit; feeding the remainder of the synthesis gas mixture at low pressure to an electrochemical cell wherein hydrogen is separated from the remainder of the synthesis gas mixture and is simultaneously pressurized; feeding the pressurized hydrogen from the electrochemical cell to join with the hydrogen generated in the pressure swing adsorption unit and recovering the combined hydrogen product. The synthesis gas mixture may be from a reformation unit and it may be subject to a water gas shift reaction. In addition to the production of hydrogen, the separation of hydrogen in the electrochemical cell increases the concentration of carbon dioxide in the residual waste gas and enables carbon dioxide recovery.

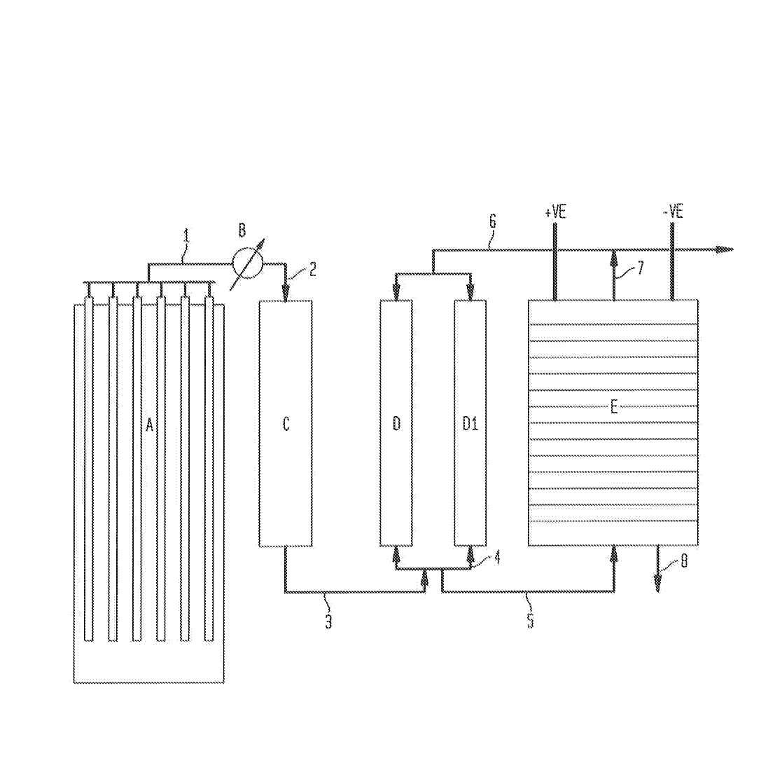

### BACKGROUND OF THE INVENTION

Conventional hydrogen production plants that are based on steam or carbon dioxide reforming of methane, or partial oxidation or auto-thermal reforming processes typically comprise a pressure swing adsorption (PSA) unit downstream to recover high purity hydrogen at high pressure. In the process, typically 70 to 90 percent hydrogen is recovered, depending on operating parameters such as the feed pressure and flow rate, feed H₂ concentration and the desired product purity. As a result, a waste gas or tail gas is generated at a low, nearly atmospheric pressure, containing unrecovered hydrogen, as well as carbon dioxide, carbon monoxide, methane, water and other trace components. This stream is typically used as a fuel for the reformer furnace.

However, if the hydrogen present in the waste gas stream can be recovered at high purity, it has greater value as a chemical compared to its fuel value. This is of particular note in auto-thermal or partial oxidation reactors, wherein heat is generated internally and an external fuel is not required to sustain the main reactions as in the case of reforming.

Particularly in the case of small hydrogen production units, the tail or waste gas stream is often wasted. There are also other processes in which small amounts of hydrogen in waste streams are vented or flared since such stream are typically at ambient pressure and contain other impurities. Conventional methods of hydrogen recovery are typically too expensive for such streams.

The present invention is able to overcome these limitations by recovering this hydrogen in the waste gas or tail gas stream and employ it as a reactive chemical species rather than a fuel stock for other processes. This recovery process will provide greater cost savings than if the entire waste gas stream from the pressure swing adsorption unit is used as a fuel.

Recovery of hydrogen from a low pressure gas stream using electrochemical means and simultaneously compressing the hydrogen using electrical energy is known in principle.

For example, as noted in US Pat Pub No 2010/0243475 A1, electrochemical processes are known for selectively transferring hydrogen from one side of an electrochemical cell to the other side. These hydrogen pumps may be used to separate hydrogen from gas mixtures containing other components which are not impacted by the electrochemical process.

### SUMMARY OF THE INVENTION

In one embodiment, there is disclosed an improved method for increasing hydrogen recovery of a hydrogen production plant, the improvement comprising recovering additional hydrogen from a low pressure waste gas stream from a pressure swing adsorption unit producing hydrogen, by feeding the low pressure waste gas stream to an electrochemical cell, separating the additional hydrogen from the low pressure waste gas stream; recovering and combining the additional hydrogen with a high pressure hydrogen product from the pressure swing adsorption unit resulting in increased hydrogen recovery.

The hydrogen is recovered from a synthesis gas stream that is produced in a reforming or partial oxidation of hydrocarbons. The pressure swing adsorption unit separates the bulk of the hydrogen from this synthesis gas and the low pressure waste gas stream which can contain some hydrogen is fed to the electrochemical cell.

The reformation process will typically be a steam or carbon dioxide reformation process which will produce a synthesis gas mixture. This synthesis gas mixture will usually contain hydrogen, carbon monoxide, carbon dioxide, methane, water and some trace impurities. In certain instances, this synthesis gas mixture can be fed to a water gas shift reactor which will increase the concentration of hydrogen while lowering the amount of carbon monoxide present in the synthesis gas mixture. The resulting synthesis gas mixture with or without enhanced hydrogen content will be fed to a pressure swing adsorption unit.

The pressure swing adsorption waste gas stream contains about 20 to 50% hydrogen as well as carbon monoxide, carbon dioxide, methane, water and other trace impurities. The CO₂ concentration in the waste gas varies from about 30% to 50%, dependent on the hydrogen concentration variation as explained earlier. This waste gas stream is passed through an electrochemical cell that contains catalyst coated electrodes on the two sides of a proton conducting electrolyte membrane. When current is passed across the electrodes, hydrogen selectively passes through the membrane and pure hydrogen is recovered on the other side. The hydrogen can also be compressed simultaneously since hydrogen can flow from the low to high pressure chamber with the applied current. The recovered hydrogen may be treated to remove moisture using known techniques such as condensation, absorption, adsorption, etc. and then can be directly combined with the main hydrogen product stream from the pressure swing adsorption unit at high pressure.

The pressure swing adsorption unit can be a typical unit containing two or more adsorbent beds. In the pressure swing adsorption unit hydrogen is separated from the synthesis gas mixture at high pressure, typically 10-30 bar, by adsorbing other components, like carbon monoxide, carbon dioxide and methane, and letting bulk of the hydrogen exit as the high pressure product. The remaining gas components that are not recovered as product, including some of the hydrogen, exit the pressure swing adsorption unit at low pressure, typically around ambient pressure, as a waste or tail gas. This gas is fed to an electrochemical cell wherein any hydrogen not recovered in the pressure swing adsorption unit is further separated, compressed in the electrochemical cell, and recovered as additional product, which can be directly combined with the main product to increase overall hydrogen production capacity of the plant.

The Electro-chemical hydrogen separation device (EHS) contains an electrolyte membrane comprising a polymer, such as commercial NAFION®, a trademark of E.I. du Pont de Nemours and Company (sulfonated tetrafluroethane copolymer) or Poly Benzyl Immidazole or PBI. These types of membranes are known as Proton Exchange Membranes (PEM), as they selectively allow only hydrogen to pass through. Proton Exchange Membranes are typically used in fuel cells, and in recent years have been extensively studied, developed and improved in terms of cost and performance. The Proton Exchange electrolyte membrane used in the Electro-chemical hydrogen separation device will allow transfer of the hydrogen from the waste gas mixture as well as create a reject stream of the other components of the waste gas mixture. This reject stream can be disposed of in an environmentally friendly manner, treated or reused in other industrial processes by the operator. For example, if it has sufficient heating value, the reject gas may be used as fuel in the reforming furnace.

Typically, the reject or waste gas stream from the Electro-chemical hydrogen separation device will have a high carbon dioxide concentration of 70 to 80% carbon dioxide. This make this stream attractive to recover pure carbon dioxide by conventional separation means.

The reject or waste gas stream is fed from the Electro-chemical hydrogen separation device to a carbon dioxide recovery process that comprises the steps of: compressing the waste gas stream, drying the waste gas stream, cooling the waste gas stream and feeding the compressed, cool, dry waste gas stream to a stripper column with a condenser temperature in the range of −30° C. to −50° C.

Pure liquid carbon dioxide is produced from the bottom of the stripper and a vent gas from the stripper is fed to the hydrogen production plant as a fuel gas.

The hydrogen that is recovered can also be simultaneously pressurized up to desired pressures of 10 to 30 bar or higher by the Electro-chemical hydrogen separation device by means of applied voltage. This pressurization will be useful as the separated hydrogen is combined with the high pressure hydrogen product that is produced from the pressure swing adsorption unit. Thus, the inventive process allows significantly higher overall hydrogen recovery from a typical hydrogen production process such as steam methane reforming, thereby increasing the net production capacity of the plant.

The power requirement for the Electro-chemical hydrogen separation device operation is dependent on a number of factors, such as membrane thickness, area, current density, differential pressure, etc. Typical values may range from 3 to 10 kwh/kg H₂. The number of cells and device architecture also play a role in power consumption. For a given configuration and operating conditions, these parameters can be optimized for the best possible overall cost and performance.

In another embodiment of the invention, there is disclosed a method for producing hydrogen comprising the steps:

a) Feeding a synthesis gas mixture to a pressure swing adsorption unit;
b) Producing hydrogen from the synthesis gas mixture in the pressure swing adsorption unit;
c) Feeding the remainder of the synthesis gas mixture to an electrochemical cell wherein additional hydrogen is separated from the remainder of the synthesis gas mixture;
d) Feeding the additional hydrogen from the electrochemical cell to join with the hydrogen generated in step b) forming a combined hydrogen product; and
e) Recovering the combined hydrogen product.

### BRIEF DESCRIPTION OF THE DRAWINGS

The FIGURE is a schematic of a separation process per the invention.

### DETAILED DESCRIPTION OF THE INVENTION

Turning to the FIGURE, there is shown a schematic representation of the process for separating hydrogen from the waste gas stream of a pressure swing adsorption system using an electrochemical cell.

A reformation unit A will produce a synthesis gas mixture. The reformation process will typically be a steam or a carbon dioxide (or a mixture of steam and CO₂) reformation process whereby steam or carbon dioxide is fed along with a hydrocarbon such as methane. These reactants are reacted in the presence of a metal-based catalyst where they will form the synthesis gas mixture of hydrogen, carbon monoxide, carbon dioxide, unreacted methane and water, as well as trace constituents.

The synthesis gas mixture is fed through line 1 to a cooler B whereby the synthesis gas mixture is reduced in temperature from 700° to 900° C. to a temperature of ˜300° C. to near ambient. The cooled synthesis gas mixture is optionally fed through line 2 to a water gas shift reaction unit whereby hydrogen content of the synthesis gas mixture is raised while the carbon monoxide content is reduced. The resultant synthesis gas mixture with the greater hydrogen content is fed through line 3 to line 4 where it will enter the pressure swing adsorption system with adsorption beds labeled D and Dl. For purposes of the present invention, the pressure swing adsorption system can have more than two adsorption beds but for discussion purposes two beds are employed.

The synthesis gas mixture fed to the pressure swing adsorption unit is typically at a pressure of 10 to 30 bar. The pressure of the product hydrogen stream from the pressure swing adsorption unit is close to the feed pressure. However, the waste gas stream exits the adsorption beds at near ambient pressure during depressurization of the bed

In a typical hydrogen pressure swing adsorption process, the components present in the feed gas other than hydrogen are adsorbed by the adsorbent material present in the bed. The adsorbent material is typically activated carbon or a zeolite such as 5A zeolite or a combination installed in layers. The temperature of the process is basically constant throughout the adsorption and desorption steps but the feed pressure is higher during the adsorption step. So in the FIGURE, when the first bed D is in adsorption mode, the synthesis gas mixture is fed through line 3 to line 4 into the bottom of bed ID, and as the synthesis gas mixture passes upwards through the bed D, the components other than hydrogen are adsorbed. Hydrogen at higher pressure close to the feed pressure will pass from the bed D through line 6. After a suitable defined time, the adsorption step for bed D will stop and the second bed D1 will act as the adsorption bed. Bed D will then be depressurized and purged to produce a desorbed gas stream. This desorbed gas mixture is the waste gas stream and is recovered at lower pressure from the bottom of bed D through line 4 and will be passed through line 5 where it will be fed into the Electro-chemical Hydrogen Separation (EHS) unit E.

The adsorption in bed D1 will operate in the same manner whereby a higher pressure feed synthesis gas mixture will enter through line 4 and the components of the synthesis gas mixture other than the hydrogen will be adsorbed in the adsorbent material of bed D1. The high purity, high pressure, hydrogen will exit through the top of the bed D1 through line 6. After a defined time, bed Dl stops adsorption and will be depressurized and desorbed by the feed of hydrogen through line 6 as bed D was after its turn as the adsorbent bed. The waste gas stream from this bed D1 will also be fed through line 4 to line 5 where it will be fed into the Electro-chemical Hydrogen Separation (EHS) unit E.

The waste purge gas stream that comes from beds D and D1 of the pressure swing adsorption unit will contain carbon monoxide, carbon dioxide, methane, water and trace impurities. It will also contain hydrogen in amounts ranging from 20 to 50%. This waste purge gas stream is fed through line 5 from the pressure swing adsorption unit into the Electro-chemical Hydrogen Separation (EHS) device E.

The device E works through the application of direct current to selectively drive hydrogen from the synthesis gas mixture through an electrolyte membrane. The hydrogen is then subject to compression within the EHS cell where it will be raised in pressure to about 10 to 30 bar or higher as desired. Higher pressures will consume somewhat higher electricity. The purified hydrogen at pressure is recovered through line 7 where it will join with the high pressure hydrogen product from the pressure swing adsorption beds D and D1 and be fed to storage or to a unit operation where hydrogen is needed. The remaining portion of the waste purge gas stream will be discarded through line 8 where it will be treated for release into the atmosphere or forwarded onto another unit operation that could use the components present therein.

The Electro-chemical Hydrogen Separation device typically comprises a stack of individual cells, each comprising a cathode and an anode separated by the proton exchange membrane electrolyte. The cathode and the anode have a layer of catalyst, typically a precious metal catalyst such as platinum. Hydrogen molecules in the anode compartment are dissociated on the anode surface and the resulting protons are transported across the proton exchange membrane to the cathode side where they recombine to form H₂ molecules again. With a set back pressure, the hydrogen exiting the Electro-chemical Hydrogen Separation device can be obtained at a desired high pressure. The principles and operation of a typical EHS unit is described in the literature (e.g. B. Rohland*, K. Eberle, R. StroÈ bel, J. Scholta and J. Garche; “Electrochemical hydrogen compressor”; Electrochimica Acta, Vol. 43, No. 24, pp. 3841-3846, 1998). Depending on the type of membrane used, the CO in the syngas may have to be removed to low levels (e.g. <200 ppm for the Nafion® type membrane). Also, other trace impurities, if present, such as NH₃, H₂S, HCl, etc. may be detrimental to the membrane and need to be removed. This can be accomplished by using a guard bed in front of the Electro-chemical Hydrogen Separation device. This operation is well known. Another consideration is that the operation of the proton exchange membrane requires presence of moisture in the gas stream. if the syngas fed to the Electro-chemical Hydrogen Separation device is dry, a humidifier may be used to introduce moisture in the syngas stream. The product hydrogen from the Electro-chemical Hydrogen Separation device would then contain some moisture, which can be removed by conventional means such as condensation, absorption or adsorption to obtain desired dry hydrogen product.

Once, the hydrogen is recovered using the electrochemical hydrogen separation device, the concentration of carbon dioxide in the remaining gas stream (stream 8) in most cases is enriched to as high as 70 to 80%. At such a high CO₂ concentration, it becomes economically attractive to recover pure CO₂ from this stream using conventional separation means (e.g. patent reference: U.S. Pat. No. 4,969,338, Nov. 13, 1990, “Method and Apparatus of Producing Carbon Dioxide in High Yields from Low Concentration Feeds”, R. Krishnamurthy and D. L. MacLean).

The carbon dioxide containing stream is passed through the steps of compression, drying, cooling and being fed to a stripper column with a condenser temperature in the range from −20° C. to −55° C. Pure liquid carbon dioxide is produced as bottoms product from the stripper and the remaining gases (methane, CO and any nitrogen) are removed at high pressure as a vent gas which can be sent back to the reforming step as a fuel gas.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. An improved method for increasing hydrogen recovery of a hydrogen production plant, the improvement comprising recovering additional hydrogen from a low pressure waste gas stream from a pressure swing adsorption unit producing hydrogen, by feeding the low pressure waste gas stream to an electrochemical cell, separating the additional hydrogen from the low pressure waste gas stream; recovering and combining the additional hydrogen with a high pressure hydrogen product from the pressure swing adsorption unit resulting in increased hydrogen recovery.

2. The method as claimed in claim 1 wherein the hydrogen production process is selected from the group consisting of stream reforming, carbon dioxide reforming, methanol reforming, and partial oxidation.

3. The method as claimed in claim 1 wherein the increased hydrogen output comprises hydrogen from the pressure swing adsorption unit and the electrochemical cell.

4. The method as claimed in claim 1 wherein the low pressure waste gas stream comprises hydrogen, carbon monoxide, methane, carbon dioxide, water and trace constituents.

5. The method as claimed in claim 1 wherein a synthesis gas is fed to the pressure swing adsorption unit.

6. The method as claimed in claim 5 wherein the synthesis gas stream is produced by the hydrogen production process.

7. The method as claimed in claim 5 wherein the synthesis gas stream is fed to a water gas shift reactor.

8. The method as claimed in claim 1 wherein the synthesis gas stream is cooled prior to being fed to the water gas shift reactor.

9. The method as claimed in claim 1 wherein the high pressure hydrogen product stream is at a pressure of 10 to 30 bar.

10. The method as claimed in claim 1 wherein the electrochemical cell contains a proton exchange electrolyte membrane.

11. The method as claimed in claim 1 wherein the proton exchange membrane is selected from the group consisting of sulfonated tetrafluoroethane copolymer and poly benzyl immidazole.

12. The method as claimed in claim 1 wherein a waste gas stream is recovered from the electrochemical cell.

13. The method as claimed in claim 12 wherein the waste gas stream contains 70 to 80% carbon dioxide.

14. The method as claimed in claim 13 wherein the carbon dioxide is recovered from the waste gas stream.

15. The method as claimed in claim 14 wherein the carbon dioxide is recovered from the waste gas stream by feeding the waste gas stream to a carbon dioxide recovery process that comprises the steps of compressing the waste gas stream, drying the waste gas stream, cooling the waste gas stream and feeding the waste gas stream to a stripper column with a condenser temperature in the range of −20° C. to −55° C.

16. The method as claimed in claim 15 wherein pure liquid carbon dioxide is produced from the bottom of the stripper.

17. The method as claimed in claim 15 wherein a vent gas from the stripper is fed to the hydrogen production plant as a fuel gas.

18. A method for producing hydrogen comprising the steps:
a) Feeding a synthesis gas mixture to a pressure swing adsorption unit;
b) Producing hydrogen from the synthesis gas mixture in the pressure swing adsorption unit;
c) Feeding the remainder of the synthesis gas mixture at low pressure to an electrochemical cell wherein additional hydrogen is separated from the remainder of the synthesis gas mixture;
d) Feeding the additional hydrogen from the electrochemical cell to join with the hydrogen generated in step b) forming a combined hydrogen product; and
e) Recovering the combined hydrogen product.

19. The method as claimed in claim 18 wherein the synthesis gas stream is from a reformer operation.

20. The method as claimed in claim 19 wherein the reformer operation is selected from the group consisting of steam and carbon dioxide reforming.

21. The method as claimed in claim 18 further comprising feeding the synthesis gas mixture to a water gas shift reactor prior to feeding to the pressure swing adsorption unit.

22. The method as claimed in claim 18 wherein the synthesis gas mixture is fed to the pressure swing adsorption unit at a pressure of 10 to 30 bar and a temperature of 15° to 50° C.

23. The method as claimed in claim 19 wherein the pressure swing adsorption unit contains two or more beds.

24. The method as claimed in claim 18 wherein the pressure swing adsorption unit operates at a pressure of 10 to 30 bar.

25. The method as claimed in claim 18 wherein the low pressure synthesis gas mixture is at ambient pressure.

26. The method as claimed in claim 18 wherein the hydrogen from the pressure swing adsorption unit is recovered at a pressure of 10 to 30 bar.

27. The method as claimed in claim 18 wherein the hydrogen in the waste gas stream is from 20 to 50% of the remainder of the synthesis gas mixture.

28. The method as claimed in claim 18 wherein the electrochemical cell contains a proton exchange electrolyte membrane.

29. The method as claimed in claim 18 wherein the proton exchange membrane is selected from the group consisting of sulfonated tetrafluoroethane copolymer and poly benzyl immidazole.

30. The method as claimed in claim 18 wherein a waste gas stream is recovered from the electrochemical cell.

31. The method as claimed in claim 30 wherein the waste gas stream contains 70 to 80% carbon dioxide.

32. The method as claimed in claim 31 wherein the carbon dioxide is recovered from the waste gas stream.

33. The method as claimed in claim 32 wherein the carbon dioxide is recovered from the waste gas stream by feeding the waste gas stream to a carbon dioxide recovery process that comprises the steps of compressing the waste gas stream, drying the waste gas stream, cooling the waste gas stream and feeding the waste gas stream to a stripper column with a condenser temperature in the range of −20° C. to −55° C.

34. The method as claimed in claim 33 wherein pure liquid carbon dioxide is produced from the bottom of the stripper.

35. The method as claimed in claim 33 wherein a vent gas from the stripper is fed to the hydrogen production plant as a fuel gas.
